(19) United States
(12) Patent Application Publication
(10) Pub. No.: US 2026/0308351 A1
(43) Pub. Date: Oct. 8, 2026

(54) PROCESS FOR PRODUCING CYCLOSILOXANES FROM SILICONE WASTE

(71) Applicant: Evonik Operations GmbH, Essen (DE)

(72) Inventors: Frauke Henning, Essen (DE); Wilfried Knott, Essen (DE); Kathrin Lehmann, Ratingen (DE); Stefan Busch, Bochum (DE); Andrea Lohse, Bottrop (DE); Sadik Amajjahe, Duesseldorf (DE); Christian Eger, Bardowick (DE)

(73) Assignee: Evonik Operations GmbH, Essen (DE)

(21) Appl. No.: 19/479,858

(22) PCT Filed: Apr. 30, 2024
(86) PCT No.: PCT/EP2024/061857

§ 371 Date: Oct. 29, 2025

(30) Foreign Application Priority Data
May 3, 2023 (EP) 23171224.1

(51) Int. Cl. C08J 11/28; C08G 77/04; C08G 77/14; C08J 11/16; C09D 5/16; C09D 183/06

(52) U.S. Cl. CPC C08J 11/28; C08G 77/045; C08G 77/14; C08J 11/16; C09D 5/1675; C09D 183/06; C08J 2383/04

(57) ABSTRACT

The invention relates to a process for producing at least one cyclosiloxane by catalyzed depolymerization of silicone waste comprising or consisting of the steps:
(i) dissolving at least a portion of the silicone waste in at least one solvent containing or consisting of at least one aliphatic hydrocarbon (K) using at least one depolymerization catalyst (D1),
(ii) optionally deactivating the at least one depolymerization catalyst (D1) and adding at least one further depolymerization catalyst (D2),
(iii) distillative removal of the at least one cyclosiloxane from the mixture,
characterized in that the at least one aliphatic hydrocarbon (K) comprises at least 16 carbon atoms.

The present invention is in the field of producing cyclosiloxanes from silicone wastes.

Silicones, also known as organosiloxanes, are materials with alternating silicon and oxygen atoms, wherein different organic radicals are bonded to the silicon. These compositions may be liquid, semi-solid or solid, depending on the molecular weight and the degree of crosslinking.

Because of their specific material characteristics, silicone components meet particular requirements in medical, pharmaceutical and food technology applications. They are physiologically entirely inert given appropriate processing. For instance, products made of silicone are encountered in food applications, in medicine and in pharmaceutical sectors. Babies' dummies and pacifiers are also produced from silicone, as are divers' goggles. In technical industrial applications, silicone appears in many cases as a material for gaskets or in dynamic applications for membranes. In the automotive sector, it is used for hoses, sheaths or as cable insulation.

In terms of its mechanical properties silicone has a crucial advantage over other rubber types. In the case of silicone said properties are preserved at a relatively stable level over a very wide temperature range while the mechanical properties of many other materials deteriorate significantly under cold or hot conditions. While inspection of the technical data sheet for an EPDM material for example might suggest it is superior to a silicone mixture in terms of its mechanical properties because the properties at room temperature are stated there, the exact opposite picture is found at high or low temperatures. Thermal stability in air for silicone is from about −80° C. to about 250° C. This property is extensively used for gaskets since the very low compression set that is typical of silicone is manifested here.

On account of their excellent stability to ozone, UV and weathering, silicone mixtures are also commonly used in outdoor applications. In addition, silicone has very low flammability and has both good electrical insulation capacity and good electrical conductivity. Silicone is chemically stable e.g.

towards vegetable and animal fats, hot water and alcohol. Stability to acids, alkalis, fuels and ketones, and also to steam is limited. Silicone additionally has very high gas permeability.

As well as industrial applications, silicone has been used for decades as a preferred elastomer in the medical sector. Silicone components are here also used as short-term implants (for shorter than 30 days in Class IIa medical devices) or long-term implants (for 30 days or longer in Class IIb medical devices), where they fulfil critical functions in devices such as heart catheters, heart pacemakers, ventilation devices, neurostimulators and defibrillators.

Silicone rubber that is to be used for long-term implants is supplied by only very few producers worldwide (for example by NuSil Technology). Production of the mixtures takes place under strict conditions imposed by the US Food and Drug Administration (FDA). Exceptional purity must likewise be ensured during processing and component production must take place in a cleanroom.

An important advantage of silicone here is that it is biocompatible and hence is well tolerated by humans. The biocompatibility of a silicone mixture is commonly demonstrated by USP Class VI classifications (USP stands for United States Pharmacopeia) or by tests according to the stricter (DIN EN) ISO 10993 standard. (DIN EN) ISO 10993 serves primarily for the testing of medical devices that are implanted in the human body for a long period or permanently. For shorter applications, classification according to USP Class VI or possibly a lower classification is sufficient.

In addition, silicone, on account of its property of being usable within a wide temperature range from about −80° C. to about 250° C., offers the option of steam sterilization (heating in an autoclave). Silicone products can thus be freed of live microorganisms, their dormant forms, viruses, etc. The good electrical insulation capabilities of silicone are also of particular significance in the medical sector.

Variation of the silicone rubbers used and of the modes of crosslinking allows silicones to take on particular properties. For instance, HTV silicone rubbers are flexible and stable within a wide temperature range from −50° C. up to 200° C., in some cases up to 300° C. They are found in gaskets in the automotive or food industry, in cable sheaths or as insulation material.

RTV silicone rubbers are valued particularly for their thermal conductivity and electrical insulation capability and are for that reason employed with preference in the electrical and electronics sector.

Liquid silicones (also LSRs, liquid silicone rubbers) have lower viscosity compared with HTV and RTV silicone rubbers. They can be rendered into a wide variety of different shapes by injection moulding and processed for example into silicone hoses. Since LSR silicones are always produced by platinum crosslinking, products based on liquid silicones can be used in medical technology sectors.

By virtue of its high stability within the human body, silicone thus constitutes very good protection of critical components and is additionally used with preference for functional parts on account of the properties mentioned.

The difference between silicone rubber and other organic elastomers is in principle that its main chains which have an inorganic structure are not composed of carbon compounds but rather are formed from combinations of silicon and oxygen atoms, wherein the fillers pyrogenic silica or precipitated silica are especially used for specific adjustment of mechanical properties such as for example Shore hardness, tensile strength and elasticity.

Depending on their physical state and vulcanization temperatures, silicone rubbers can be divided into three groups:

Silicone rubbers referred to as HTV (high temperature vulcanizing) or HCR (high consistency rubber) are those having a solid raw material. They are vulcanized at high temperatures typically between 140° C. and 200° C. Crosslinking is effected by peroxides or by an addition reaction using platinum compounds as catalyst.

Liquid silicone or LSR (liquid silicone rubber) as raw material is a (viscous) liquid and consists of two components that are mixed directly prior to processing. Crosslinking is effected by addition reaction at temperatures similar to those for the HTV types, generally with significantly faster crosslinking.

Both silicone types can be coloured. Finished elastomer articles made from HTV silicone and LSR silicone barely differ in their properties.

The third group are what are called RTV (room temperature vulcanizing) silicones. In this type, crosslinking already occurs at room temperature. They are extensively used as adhesive and/or sealant compounds or in prototype production. They are available both as one-component and as two-component systems.

As advantageous as the use properties derivable from the exceptional chemical stability of the silicones are for the service life of the articles manufactured therefrom, the stability thereof is troublesome in the disposal of the silicones at the end of their use (life cycle). These silicones at the end of their use (life cycle) are also referred to as end-of-life silicones or simply as silicone waste. The terms “silicone wastes” and “end-of-life silicones” are in the context of the present invention used synonymously.

The literature describes a multiplicity of processes for recycling silicones in general and vulcanized silicone rubber in particular. Depolymerization of silicones typically employs acidic or basic catalysts. The subsequent distillative removal of the cyclosiloxanes formed during depolymerization requires high temperatures. The prior art typically describes processes at a reaction temperature of >200° C. Processing at such high temperatures generally affords distillates contaminated by decomposition products of the fillers, dyes, adhesion promoters, vulcanization catalysts, moisture-possibly concealed in the form of silanol groups- and in some cases process solvents. Further purifications by filtration, extraction, phase separation or further distillation steps are necessary to obtain cyclosiloxanes in high purity. The separation of undesired impurities or undesired siloxane constituents normally requires further purification of the obtained cyclosiloxanes so that these may be universally used for producing new specialty silicones. Furthermore, typically not every type of silicone is depolymerizable with the same catalyst and the same process. While unfilled low-viscosity silicones depolymerize relatively easily with strong acids or bases and it is thus possible to generate cyclosiloxanes by distillation, the picture for filled silicones is quite distinct and differentiated. The fillers and pigments present in silicone elastomers can inhibit the depolymerization catalysts used, either by purely physical adsorption of the depolymerization catalysts on the filler surface or by chemical reactions with the depolymerization catalysts. In addition, fillers can undergo stronger crosslinking, agglomeration or chemical modification during depolymerization and this can lead to a strong viscosity increase right through to gelling of the mixture.

In their review article “Degradation of silicone-based materials as a driving force for recyclability”, Polym Int 2022; 71:521-531 (https://doi.org/10.1002/pi.6340), B. Rupasinghe and J. C. Furgal provide a general overview of the prior art having regard to the decomposition of silicones by depolymerization and the associated challenges in silicone recycling. They conclude that there remains a need to make the catalytic processes underlying silicone recycling “greener”. It is especially said to be necessary that the processes become more energy efficient and if possible employ only environmentally friendly solvents or even do without solvents altogether.

In their article “Full Circle Recycling of Polysiloxanes via Room-Temperature Fluoride-Catalyzed Depolymerization to Repolymerizable Cyclics”, ACS Appl. Polym. Mater. 2021, 3, 4, 1828-1839 (https://doi.org/10.1021/acsapm.0c01406) the same authors describe a process for recycling polysiloxanes by fluoride-catalysed depolymerization at room temperature to afford repolymerizable cyclics. Different solvents were examined for their suitability. The process was most efficient with tetrahydrofuran (THF) as solvent. However, the boiling point of THE is lower than that of cyclosiloxanes, thus impeding the distillative separation of the cyclosiloxanes from the reaction mixture.

U.S. Pat. No. 5,110,972 discloses numerous solvents for production of cyclosiloxanes from silicone polymers. It specifically describes a process for cracking high molecular weight silicone polymers, wherein the process comprises the steps of: dissolving the silicone polymer in an organic solution comprising an acid and heating the resulting mixture until the silicone polymer is substantially dissolved; adding a base; and removing cyclosiloxanes from the solution by distillation. It is likewise described therein that the solvents shall have a particular profile of properties. They shall be cost effective and safe for example. They shall be capable of swelling cured silicones. They shall further be easily separable from the cyclosiloxanes and solid by-products. In this context it is described that the solvents shall have a higher boiling point than tetrameric or pentameric cyclosiloxanes in order that the solvents need not be removed by distillation. The solvents shall ideally also be water-insoluble so that water-soluble by-products and impurities may be removed by a water extraction. Solvents disclosed include inter alia aliphatic hydrocarbons or oils but it is not specified which aliphatic hydrocarbons/oils may be employed to achieve the properties desired above. Solvents described as particularly suitable include Butyl Carbitol™ (also referred to as diethylene glycol monobutyl ether, butyl diglycol or (2-(2-butoxyethoxy) ethanol) and Koppers' Methylnaphthalene Fraction™ (a hydrocarbon fraction containing predominantly alkyl naphthalenes). However, it is described that the employed solvents are co-distilled during distillation of the cyclosiloxanes and are thus present in the distillate, contrary to what is desired. In addition, experiments carried out by the inventors have shown that Butyl Carbitol™ is at least not generally suitable as a solvent since the employed silicone fractions cannot be dissolved (see non-inventive example 10 below). The possible uses thus appear very limited. In addition, hydroxyfunctional compounds such as Butyl Carbitol™ have the disadvantage that they can cause undesirable side reactions which can lead to gelation of the batch. Koppers' Methylnaphthalene Fraction™ in turn has the disadvantage that it contains aromatic hydrocarbons. Aromatic hydrocarbons, in particular polycyclic hydrocarbons, are increasingly classified as reprotoxic. They are additionally harmful to the environment on account of their toxicity to aquatic organisms with long-lasting effects. Their use is therefore undesirable, not only because they pose a health risk to employees in industrial use, but also because residual quantities remain in the cyclosiloxanes obtained and thus contaminate the downstream products with aromatic hydrocarbons. U.S. Pat. No. 5,110,972 thus addresses the most important questions when selecting a suitable solvent but does not offer satisfactory solutions. For instance examples D and E disclose a biphasic distillate which contains both water and solvent in addition to the cyclosiloxanes. The cyclosiloxane yield is determined as a fractional sum from the analysis of the distillate and the cold trap residue without disclosing the precise composition of the two fractions. A workup and isolation of purified, largely anhydrous cyclosiloxane mixtures in a further process step is not disclosed but would be necessary for the use of the cyclosiloxane mixtures to produce new silicone products.

It was accordingly an object of the present invention to provide a process for producing cyclosiloxanes which has advantages over the prior art.

It is especially an object of the present invention to develop a process for producing cyclosiloxanes from silicone waste which may be performed at moderate temperatures, causes no harmful emissions to air or water and in one step affords cyclosiloxane mixtures in high purity which are ideally widely usable, after only minor further purification steps, if any, for producing organomodified siloxanes, silicone oils, silicone rubbers or silicone elastomers. The process should moreover preferably be robust, cause no gelation or encrusting in the reactor and be applicable for a multiplicity of different end-of-life silicones.

It has now been found that, surprisingly, this object is achieved by a special process for producing cyclosiloxanes which employs at least one solvent containing or consisting of at least one aliphatic hydrocarbon (K) having at least 16 carbon atoms as described in the claims.

The invention accordingly firstly provides a process for producing at least one cyclosiloxane by catalyzed depolymerization of silicone waste comprising or consisting of the steps:
(i) dissolving at least a portion of the silicone waste in at least one solvent containing or consisting of at least one aliphatic hydrocarbon (K) using at least one depolymerization catalyst (D1),
(ii) optionally deactivating the at least one depolymerization catalyst (D1) and adding at least one further depolymerization catalyst (D2),
(iii) distillative removal of the at least one cyclosiloxane from the mixture,
wherein the at least one aliphatic hydrocarbon (K) comprises at least 16 carbon atoms.

The invention further provides for the use of at least one aliphatic hydrocarbon (K) as described above as a solvent or as a solvent constituent in the production of at least one cyclosiloxane from silicone waste.

The invention yet further provides for a composition obtained as a distillate of the process according to the invention, characterized in that the mass fraction of the entirety of all cyclosiloxanes based on the total mass of the composition is at least 90%, preferably at least 92%, in particular at least 94% and the mass fraction of the entirety of all aliphatic hydrocarbons (K) based on the total mass of the composition is at most 10%, preferably at most 8%, in particular at most 6%.

The invention yet further provides for the use of the at least one cyclosiloxane produced by the process according to the invention or of the composition according to the invention for production of organomodified siloxanes, silicone oils, silicone rubbers or silicone elastomers.

The invention yet further provides silicones, preferably selected from the group consisting of organomodified siloxanes, silicone oils, silicone rubbers or silicone elastomers produced using the at least one cyclosiloxane produced by the process according to the invention or using the composition according to the invention.

The invention yet further provides for the use of the correspondingly produced silicones, preferably selected from organomodified siloxanes, as plastics additives, defoamers, foam stabilizers (for example polyurethane foam stabilizers), emulsifiers, demulsifiers, rheology additives, hydrophobizing agents, wetting agents, textile additives, paint additives, levelling additives, dispersing additives or as additions in polishes, cleaning compositions and cosmetic preparations or for producing silicone release coatings.

In the context of the present invention use is also made of the M, D, T and Q designations for organopolysiloxane constructional units. Provided as a reference for the definition thereof is W. Noll, Chemie und Technologie der Silicone, Verlag Chemie, Weinheim Bergstr., 1960, page 2 ff. Silicones are to be understood as meaning compounds comprising D units where D=[R₂SiO_{2/2}], wherein R is an organic radical, preferably a hydrocarbon radical, in particular a methyl radical.

Advantageous configurations of the subject-matter of the invention can be gathered from the claims, the examples and the description. Furthermore, it is explicitly pointed out that the disclosure relating to the subject-matter of the present invention includes all combinations of individual features of the present or subsequent description of the invention and of the claims. More particularly, embodiments of one subject of the invention are also applicable mutatis mutandis to the embodiments of the other subjects of the invention.

As already elucidated hereinabove the process according to the invention is a process for producing at least one cyclosiloxane by catalyzed depolymerization of silicone waste comprising or consisting of the steps:
(i) dissolving at least a portion of the silicone waste in at least one solvent containing or consisting of at least one aliphatic hydrocarbon (K) using at least one depolymerization catalyst (D1),
(ii) optionally deactivating the at least one depolymerization catalyst (D1) and adding at least one further depolymerization catalyst (D2),
(iii) distillative removal of the at least one cyclosiloxane from the mixture,
characterized in that the at least one aliphatic hydrocarbon (K) comprises at least 16 carbon atoms.

The wording “at least one” is synonymous with the wording “one or more”. The wording “at least one cyclosiloxane” is thus synonymous with the wording “one or more cyclosiloxanes”. The process therefore allows the production of one or more cyclosiloxanes, i.e. one cyclosiloxane or a mixture of different cyclosiloxanes. However, it is preferable to obtain a mixture of different cyclosiloxanes instead of a single cyclosiloxane. The product of the process thus preferably comprises or consists of a mixture of different cyclosiloxanes.

Preference is therefore given to a process for producing cyclosiloxanes from silicone waste by catalyzed depolymerization thereof comprising or consisting of the steps:
(i) dissolving at least a portion of the silicone waste in at least one solvent containing or consisting of at least one aliphatic hydrocarbon (K) using at least one depolymerization catalyst (D1),
(ii) optionally deactivating the at least one depolymerization catalyst (D1) and adding at least one further depolymerization catalyst (D2),
(iii) distillative removal of the cyclosiloxanes from the mixture,
wherein the at least one aliphatic hydrocarbon (K) comprises at least 16 carbon atoms.

Steps (i), (ii), and (iii) are performed in the specified sequence, i.e. in the sequence (i), (ii), and (iii), wherein step (ii) is optional and may be omitted. The process steps may follow one another directly or indirectly. The process may comprise further upstream steps, intermediate steps or downstream steps, such as for example a purification of the reactants, the intermediates and/or the end products and/or a conversion of the end products into downstream products. A purification of the end product, i.e. of the cyclosiloxanes/the cyclosiloxane mixture may for example be carried out by deodorization under vacuum or filtration using filtration aids and presupposes that a technical purity of at least 90%, preferably at least 92%, in particular at least 94%, has already been achieved. Step (iii) may also be followed indirectly or directly by step (i) again, so that the process is performed one or more times, i.e. as a recycle process. After distillative removal of the cyclosiloxanes from the mixture the remaining distillation residue may for example be resupplied with silicone waste and further solvent as required and/or one or more depolymerization catalysts (D1) as required. If the process is performed as a recycle process it is therefore advantageous when the solvent remains in the distillation residue and/or is recycled to the distillation residue. If the process is performed as a recycle process it is further advantageous when optional step (ii) is eschewed. The distillation residue may also be worked up prior to reuse. It may be advantageous to separate solid constituents of the distillation residue (for example fillers) from the liquid constituents of the distillation residue by separation methods known to those skilled in the art and only recycle the latter to the recycle process. It is especially also possible to purify the solvent after step (iii) by washing out water-soluble constituents with water and recycling it back into the process. Although the process is preferably a discontinuous process, a continuous process is conceivable. In the discontinuous case the reactor employed may be for example a batch reactor while in the continuous case it may in turn be a continuous stirred tank reactor (CSTR) or a tubular reactor/plug flow reactor.

The process according to the invention allows the production of one cyclosiloxane or of mixtures of different cyclosiloxanes in high purity. Cyclosiloxanes are known to the person skilled in the art. Siloxanes consisting exclusively of D-units are concerned here. These are preferably siloxanes of formula Dₙ where n≥3 and where D=[R₂SiO_{2/2}], wherein R is an organic radical, preferably a hydrocarbon radical, in particular a methyl radical. The radicals R may be identical or different. However, the radicals R are preferably identical. It is particularly preferable when all radicals R are methyl radicals. The most commercially important and, in the context of the present invention, preferred cyclosiloxanes are hexamethylcyclotrisiloxane (D₃), octamethylcyclotetrasiloxane (D₄), decamethylcyclopentasiloxane (D₅) and dodecamethylcyclohexasiloxane (D₆), tetradecamethylcycloheptasiloxane (D₇), hexadecamethylcyclooctasiloxane (D₈).

The process according to the invention may be performed both on fluidly viscous and on partially or completely cured silicone wastes.

A preferred embodiment of the invention provides in the case especially of completely cured silicone wastes for comminution thereof into a chunk material which upon termination of comminution preferably has a maximum diameter of at most 5 cm, yet more preferably of 1 to 10 mm, particularly preferably of 3 to 6 mm. Preferably according to the invention the optional comminution of the material may be effected for example using a crusher, a shredder, a mill, a hammer mill, using rollers or a kneader or using cutting machines. Flexible silicone wastes can initially be cold embrittled by contact for example with liquid nitrogen or else dry ice pellets. The thus markedly reduced elasticity facilitates suitable comminution.

As is evident to those skilled in the art the process according to the invention is preferably undertaken in reactors having appropriate stirring apparatuses, kneaders and/or shearing internals to achieve effective commixing.

The process is not limited to a particular silicone waste. However, it is preferable when the silicone waste contains or consists of silicone elastomers and/or silicone rubbers. Suitable silicone waste also includes silicone oils. Since silicone oils are already liquid, the proportion of the solvent comprising at least one aliphatic hydrocarbon (K) to be used according to the invention may be markedly reduced.

In a preferred embodiment of the invention the process according to the invention relates to a process for recycling/upcycling of silicone wastes, in particular of silicone adhesive wastes and/or silicone sealant wastes and/or silicone rubber wastes.

In a particularly preferred embodiment of the invention the process according to the invention has the feature that the silicone wastes comprise silicone adhesives and/or silicone sealants, preferably silicone adhesive and/or silicone sealant cartridges, in particular silicone adhesive and/or silicone sealant residues in and/or on polyolefin containers, preferably PE containers, preferably comprising HDPE and/or LDPE. Customary silicone adhesive and/or silicone sealant cartridges comprise a silicone adhesive compound and/or silicone sealant compound in a polyolefin container, preferably polyethylene container (PE container), which allows expulsion of the silicone adhesive compound and/or silicone sealant compound by application of pressure, wherein the container casing is typically made of HDPE (high-density polyethylene) and the semi-transparent container components (plunger and applicator tip) are normally made of LDPE (low-density polyethylene). HDPE and LDPE are known to those skilled in the art. HDPE has a high density of between 0.94 g/cm³ and 0.97 g/cm³; LDPE by contrast has a lower density of between 0.915 g/cm³ and 0.935 g/cm³. The process according to the invention thus especially also allows depolymerization of silicone waste, even if said waste still contains non-silicone-based plastics residues, for example HDPE and LDPE, in addition to the silicon constituent.

If the silicone waste contains a filler this is liberated through the reaction and dissolution of the silicone constituent according to the invention. At the end of the digestion according to the invention the small particle size particles of non-silicone-based plastics residues may be separated from the filler-interspersed solvent using a coarse sieve for example, said solvent then being separable for example by settling of the solid, finely divided filler.

In accordance with the invention and without narrowing the presented teaching, as an advantageous embodiment it is of course also possible to find further solutions for the basic process operations discussed here, for example filtrative removal or centrifugal separation of the filler from the solvent.

It is preferable when the silicone waste contains or consists of such silicone elastomers and/or silicone rubbers which in turn contain filler. Filler-containing silicone elastomers or silicone rubbers are also referred to as filled silicone elastomers or silicone rubbers. The filler proportion is preferably 5% to 75% by mass based on the total mass of the filled silicone elastomer/silicone rubber. The filler may be an organic filler or an inorganic filler for example. It is preferable when the filler is selected from the group consisting of activated carbon, carbon black, graphite, carbon nanotubes, graphene, organic or inorganic dyes, silicas (for example precipitated silicas or pyrogenic silicas which may in each case be hydrophilized or hydrophobized), chalk, metal oxides, metal hydroxides, metal oxide hydroxides, in particular aluminium oxide, aluminium hydroxide and aluminium oxide hydroxide and inorganic pigments. The silicone elastomers and silicone rubbers may comprise further additives, such as drying agents, adhesion promoters and catalysts and also have organic copolymer fractions.

After the separation of fillers and non-silicone-based plastics, the process according to the invention accordingly allows upcycling of the dissolved silicone to afford cyclosiloxanes that may readily be employed for a multiplicity of downstream reactions.

In the present invention the term “upcycling” therefore refers to the transformation of silicone wastes into higher-value products. An upgrading of material is therefore effected. Based on the definition in I. Vollmer et al., Angew. Chem. Int. Ed. 2020, 59, 15402-15423, the term “upcycling” thus preferably refers in the context of the present invention to the transformation of silicone waste into chemicals having a higher market value than monomers or pyrolysis oil.

The term “end-of-life silicones/silicone wastes” encompasses in the context of the teaching of the invention all silicone-based or silicone-containing products and also products with adhering silicone or contaminated with silicone that are close to reaching and/or have already completely reached the end of their respective technical service life or shelf life or would be intended for disposal for any other reason. The shelf life or service life here describes the time for which a material or an article can be used without the replacement of core components or complete failure. In the context of the teaching this also includes silicone adhesives and/or silicone sealants (for example in cartridges) that are close to reaching the end of their shelf life or their expiry date and/or have exceeded this (assessed according to the degree of hardening to be expected and/or which has already occurred), as well as for example varyingly old sprue and/or stamping waste from silicone rubber production or else discarded electronic scrap containing silicone-sealed components/component assemblies. In the context of the teaching of the invention the term “end-of-life silicones/silicone wastes” also comprises all silicone wastes, including production wastes, which do not meet the product specification desired in each case, for example injection moulded parts having deficits in their mechanical properties, dimensions or appearance. It comprises in particular all those silicones or silicone-containing components or components with adhering silicone or contaminated with silicone that would otherwise be intended for disposal in the usual manner and are accordingly regarded as waste. It thus also comprises for example silicone adhesive cartridges and/or silicone sealant cartridges, in particular used silicone adhesive cartridges and/or silicone sealant cartridges, intended for disposal which still have silicone residues adhering to or present in and on them. As already indicated hereinabove the terms “silicone wastes” and “end-of-life silicones” are to be understood as being synonymous in the context of the present invention.

Depolymerization of the silicone waste requires the use of one or more depolymerization catalysts. As described above, the process according to the invention employs at least one depolymerization catalyst (D1) and optionally also at least one depolymerization catalyst (D2).

It is preferable when the at least one depolymerization catalyst (D1) and optionally the at least one depolymerization catalyst (D2) are selected from the group consisting of Brønsted acids, Lewis acids, Brønsted bases and Lewis bases.

It is preferable when such Brønstedacids used as a depolymerization catalyst (D1) or (D2) have a pKA of at most-1.30, preferably at most-2.90, in particular at most-4.90. Brønsted acids having a pKA of at most-1.30 are preferably selected from the group consisting of methanesulfonic acid and p-toluenesulfonic acid. As a Brønsted acid having a pKA of at most-2.90 concentrated sulfuric acid is preferred Brønsted acids having a pKA of at most-4.90 are preferably selected from the group consisting of perfluoroalkanesulfonic acids (such as heptafluoropropanesulfonic acids, pentafluoroethanesulfonic acids, trifluormethanesulfonic acids), perchloric acid and chlorosulfonic acid. Perfluoroalkanesulfonic acids are particularly preferred. Trifluoromethanesulfonic acid is very particularly preferred. Sulfonic acid- or perfluoroalkylsulfonic acid-acidified ion exchange resins are likewise preferred.

It is preferable when such Brønstedbases used as a depolymerization catalyst (D1) or (D2) have a pK_{B} of at most 10, preferably at most 5 and in particular at most 0.

The Brønsted bases are preferably selected from the group consisting of alkali metal hydroxides, amines, quaternary ammonium hydroxides, quaternary phosphonium hydroxides, phosphonitrile chlorides and phosphazenes.

Preferred alkali metal hydroxides are sodium hydroxide and potassium hydroxide.

Preferred amines are non-volatile amines, in particular bicyclic diaza compounds (for example diazabicycloundecene (DBU), 1,4-diazabicyclo[2.2.2]octane (DABCO), guanidines (for example tetramethylguanidine), tertiary polyalkylamines (for example pentamethyldiethylenetriamine) and peralkylated polyalkylenamines.

Preferred quaternary ammonium hydroxides are tetraalkylammonium hydroxides, in particular tetramethylammonium hydroxide, tetraethylammonium hydroxide, tetrapropylammonium hydroxide and tetrabutylammonium hydroxide.

Preferred quaternary phosphonium hydroxides are tetraalkylphosphonium hydroxides, in particular tetramethylphosphonium hydroxide, tetraethylphosphonium hydroxide, tetrapropylphosphonium hydroxide and tetrabutylphosphonium hydroxide.

The phosphonitrile chlorides may be linear or cyclic.

The phosphazenes may be halogen-containing or halogen-free. A preferred phosphazene is tert-butyliminotri(pyrrolidino)phosphorane.

The depolymerization catalysts (D1) and/or (D2) may also be selected from the group consisting of quaternary ammonium halides and quaternary phosphonium halides, preferably from the group consisting of tetraalkylammonium halides and tetraalkylphosphonium halides. The alkyl radicals may be selected independently of one another, i.e. be identical or different. It is preferable when all alkyl radicals are identical.

The depolymerization catalysts (D1) and/or (D2) may therefore also be selected from the group consisting of tetraalkylammonium fluorides (for example tetramethylammonium fluoride, tetraethylammonium fluoride, tetrapropylammonium fluoride and tetrabutylammonium fluoride), tetraalkylphosphonium fluorides (for example tetramethylphosphonium fluoride, tetraethylphosphonium fluoride, tetrapropylphosphonium fluoride and tetrabutylphosphonium fluoride), tetraalkylammonium chlorides (for example tetramethylammonium chloride, tetraethylammonium chloride, tetrapropylammonium chloride and tetrabutylammonium chloride) and tetraalkylphosphonium chlorides (for example tetramethylphosphonium chloride, tetraethylphosphonium chloride, tetrapropylphosphonium chloride and tetrabutylphosphonium chloride). A suitable tetraalkylphosphonium compound having different alkyl radicals is for example tributyloctylphosphonium chloride.

The abovementioned quaternary ammonium compounds and quaternary phosphonium compounds employed as depolymerization catalysts (D1) and/or (D2) may be employed as pure substance or as an aqueous solution.

Numerous compounds are thus employable as depolymerization catalysts (D1) and/or (D2). However, it is preferable when the at least one depolymerization catalyst (D1) and optionally the at least one depolymerization catalyst (D2) is selected from Brønsted acids, preferably trifluoromethanesulfonic acid, or from Brønsted bases, preferably selected from the group consisting of alkali metal hydroxides, tetraalkylammonium hydroxides, tetraalkylphosphonium hydroxides, phosphazenes and guanidines.

In the above-cited article “Full Circle Recycling of Polysiloxanes via Room-Temperature Fluoride-Catalyzed Depolymerization to Repolymerizable Cyclics”, ACS Appl. Polym. Mater. 2021, 3, 4, 1828-1839 (https://doi.org/10.1021/acsapm.0c01406) B. Rupasinghe and J. C. Furgal describe the special suitability of fluorides as depolymerization catalysts. Fluorides, however, have the great disadvantage that under the reaction conditions (e.g. under formation of SiF₄) they can damage reactors made of glass or enamel. Amines or ammonium compounds or their decomposition products in turn often have an unpleasant odour. Alkali metal hydroxides are often less suitable in the case of filled silicones due to possible side reactions with the filler. For these reasons it is particularly preferable to employ tetralkylphosphonium hydroxides as depolymerization catalysts (D1) and/or (D2).

Step (i) preferably employs 0.05 to 10 parts by weight, preferably 0.1 to 3.0 parts by weight, in particular 0.2 to 1.5 parts by weight, of the at least one depolymerization catalyst (D1) and optionally of the at least one depolymerization catalyst (D2) based on 100 parts by weight of the silicone constituent of the silicone waste.

According to the invention at least one solvent containing or consisting of at least one aliphatic hydrocarbon (K) is further employed, wherein the at least one aliphatic hydrocarbon (K) comprises at least 16 carbon atoms.

The aliphatic hydrocarbons (K) are compounds that are composed only of carbon and hydrogen atoms and are not aromatic. The aliphatic hydrocarbons (K) may be saturated or unsaturated but it is preferable when the aliphatic hydrocarbons (K) are saturated. This has the advantage that they are chemically inert under the reaction conditions. The aliphatic hydrocarbons (K) may be linear or branched or cyclic, but preferably are branched since they then have a lower melting point than their linear structural isomers. Particularly preferred aliphatic hydrocarbons (K) are thus saturated and branched, i.e, particularly preferred aliphatic hydrocarbons (K) are branched alkanes.

The at least one aliphatic hydrocarbon (K) has at least 16, preferably 16 to 60, in particular 16 to 50, carbon atoms. It is thus also preferable when the at least one aliphatic hydrocarbon (K) is selected from branched alkanes preferably having 16 to 60, in particular 16 to 50, carbon atoms. The preferred saturated, branched, aliphatic hydrocarbons (K) (branched alkanes for short) have the molecular formula CₙH₂ₙ₊₂, wherein the index n is an integer of not less than 16, preferably 16 to 60, in particular 16 to 50. The index n may therefore be for example 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 or 60, but may also be higher. It is particularly preferable when the aliphatic hydrocarbon (K) is a compound of formula C₁₆H₃₄, the main component of tetrabutane.

It is preferable when the mass fraction of the entirety of all aliphatic hydrocarbons (K) in the solvent, based on the total mass of the solvent, is at least 99.0%, preferably at least 99.9%, in particular 100.0%.

It is further preferable when the evaporation loss of the at least one solvent and/or of the at least one aliphatic hydrocarbon (K) determined according to ASTM D 972 (in particular ASTM D 972, 2022 edition) after 22 h at 107° C. is at most 0.8%, preferably at most 0.2%, in particular at most 0.15%, reported as the mass loss based on initial mass.

It is further preferable when the Noack volatility of the at least one solvent and/or of the at least one aliphatic hydrocarbon (K) determined according to ASTM D 5800 (preferably ASTM D 5800, 2021 edition) after 1 h at 250° C. is at most 45%, preferably at most 40%, in particular at most 10%, reported as the mass loss based on initial mass.

It is likewise preferable when the Noack evaporation loss of the at least one solvent and/or of the at least one aliphatic hydrocarbon (K) determined according to DIN 51581 (preferably according to DIN 51581-1:2011-09) after 1 h at 250° C. is at most 45%, preferably at most 40%, in particular at most 10%, reported as the mass loss based on initial mass.

It is further preferable when the at least one solvent and/or the at least one hydrocarbon (K) are liquid at 25° C.

In order to allow simple mixing it is preferable when the at least one solvent and/or the at least one hydrocarbon (K) have a kinematic viscosity of not more than 1000 mm²/s, preferably not more than 500 mm²/s, in particular not more than 150 mm²/s, at 20° C. determined according to DIN EN ISO 3104 (preferably according to DIN EN ISO 3104:2021-01). The lower limit of viscosity should be as low as possible. It is therefore also preferable when the at least one solvent and/or the at least one hydrocarbon have a kinematic viscosity of 1 to 1000 mm²/s, preferably of 5 to 500 mm²/s, in particular of 10 to 150 mm²/s, at 20° C. determined according to DIN EN ISO 3104 (preferably according to DIN EN ISO 3104:2021-01).

It is also advantageous when at standard pressure (1013.25 hPa) the at least one solvent and/or the at least one hydrocarbon (K) have a boiling point or boiling range of at least 260° C., preferably of at least 280° C., in particular of at least 300° C.

It is preferable when the at least one solvent is selected from the group of mineral oil products, in particular from the group consisting of fuel oil, diesel, paraffin oil, white mineral oil (also in medical grade paraffinum liquidum)) and tetrabutane.

Suitable paraffin oils are commercially available for example from Shell under the designations Shell Ondina X and Shell Risella X. They comprise numerous paraffin oils that exhibit the abovementioned physicochemical parameters (evaporation loss, Noack volatility, Noack evaporation loss, viscosity, boiling point or boiling range) in the desired value ranges, for example Shell Risella X 415 and Shell Risella X 430.

A further suitable paraffin oil is commercially available from Evonik under the designation TEGOSOFT® IHD BASIC. This is a mixture of branched C₁₆-, C₂₀- and C₂₄-alkanes. The term “Cₓ” represents x carbon atoms as is generally customary. A Cₓ-alkane is therefore an alkane having x carbon atoms.

Tetrabutane (also known as technical tetrabutane or tetrabutane (tech.)) is a mixture of branched paraffins and comprises as the main constituent hydrocarbons having 16 carbon atoms. Particular preference is given to a tetrabutane comprising at most 2.0% hydrocarbons having less than 16 carbon atoms, at least 60.0% hydrocarbons having 16 carbon atoms and at most 40.0% hydrocarbons having more than 16 carbon atoms in each case reported as the mass fraction based on the total mass of the tetrabutane. Such a tetrabutane is commercially available from Evonik for example.

The amount of employed solvent is determined by the amount of silicone waste to be converted. It is preferable when the solvent partially, preferably predominantly, in particular completely, surrounds the silicone waste.

Preference is therefore given to a process where in step (i) 10 to 250 parts by weight, preferably 10 to 200 parts by weight, in particular 50 to 150 parts by weight, of the at least one solvent are employed based on 100 parts by weight of the silicone waste.

Step (i) and/or step (ii) may optionally be carried out with addition of silicone oils or silicone additives such as for example wetting agents, emulsifiers, defoamers, dispersing agents, hydrophobizing agents or waxes. These process additives are preferably polymers. Especially process additives based on (organo-modified) silicones/siloxanes have the advantage of good system solubility.

It is preferable when the silicone additive is selected from the group consisting of hexamethyldisiloxane, polydimethylsiloxane, α,ω-dialkoxypolydimethylsiloxane, especially α,ω-dimethoxypolydimethylsiloxane or α,ω-diethoxypolydimethylsiloxane, divinyltetramethyldisiloxane or α,ω-divinylpolydimethylsiloxane, α,ω-dialkylpolydimethylsiloxane, especially α,ω-dimethylpolydimethylsiloxane or α,ω-dioctylpolydimethylsiloxane, siloxanes functionalized with polyethers or glycols, in particular hydrolysis-stable polyether siloxanes having (poly) ether radicals bonded to the siloxane via SiC bonds.

In summary it is thus preferable when at least one silicone additive selected from the group consisting of hexamethyldisiloxane, polydimethylsiloxane, α,ω-dialkoxypolydimethylsiloxane, especially α,ω-dimethoxypolydimethylsiloxane or α,ω-diethoxypolydimethylsiloxane, divinyltetramethyldisiloxane or α,ω-divinylpolydimethylsiloxane, α,ω-dialkylpolydimethylsiloxane, especially α,ω-dimethylpolydimethylsiloxane or α,ω-dioctylpolydimethylsiloxane, siloxanes functionalized with polyethers or glycols, in particular hydrolysis-stable polyether siloxanes having (poly) ether radicals bonded to the siloxane via SiC bonds, is additionally employed in step (i) and/or step (ii).

The use of silicone additives especially has the advantage that it can improve the cyclosiloxane yield.

It is preferable when step (i) is carried out at a temperature of 30° C. to 180° C., preferably of 45° C. to 160° C., in particular of 70° C. to 130° C. It is further preferable when step (i) is performed at standard pressure (1013.25 hPa)+500 hPa, preferably +200 hPa, in particular ±100 hPa. Step (i) may be performed with blanketing or introduction of protective gas. For inertizing, drying or deodorizing the pressure change process may be followed by application of any vacuum down to 1 mbar. If step (i) is performed at superatmospheric pressure, pressure-resistant apparatuses should be employed. It is likewise preferable when step (i) is performed over a period of 2 h to 12 h, preferably 3 h to 9 h, in particular 4 h to 8 h.

It may be preferable when the process according to the invention comprises step (ii) and the at least one depolymerization catalyst (D1)
a) is deactivated with at least one Brønsted base when the at least one depolymerization catalyst (D1) is selected from Brønsted acids; or
b) is deactivated with at least one Brønsted acid when the at least one depolymerization catalyst (D1) is selected from Brønsted bases.

The Brønsted base or Brønsted acid used for deactivation by neutralization may be solid, liquid or gaseous.

If a gaseous base is selected for deactivation it is preferably ammonia. If a solid and/or liquid base is selected for deactivation it is preferably a hydrogencarbonate and/or carbonate of the alkali and/or alkaline earth metals and/or an organic amine base in the form of a primary or secondary amine and/or an acetate salt.

An optionally desired separation of the salt precipitated in the optional neutralization may preferably be effected by filtration. If filled silicone wastes are used the liberated filler proportion may preferably be separated together with the precipitated salt.

In a further embodiment preferred according to the invention the liberated filler proportion is initially separated and the thus obtained filtrate proportion is subsequently neutralized by introduction of a solid, liquid or gaseous base.

It will be clear to those skilled in the art that, before processing unknown silicone wastes, it is advisable to take a representative sample and to carry out a test digestion on a laboratory and/or pilot-plant scale in order to determine how high the actual silicone content is and also what proportion of silicone-free components is to be expected. These include inter alia binders, plastics and, for example in the case of electronic scrap, metals, ceramics, etc.

It is preferable when step (ii) is carried out at a temperature of 0° C. to 150° C., preferably of 20° C. to 130° C., in particular of 30° C. to 120° C. It is likewise preferred when step (ii) is performed at standard pressure (1013.25 hPa). It is likewise preferable when step (ii) is performed over a period of at most 6 h, preferably of 0.5 h to 5 h, in particular of 1 h to 3 h.

If the process according to the invention comprises step (ii) it is further preferable when the at least one depolymerization catalyst (D2)
a) is selected from Brønsted bases when the at least one depolymerization catalyst (D1) is selected from Brønsted acids or
b) is selected from Brønsted acids when the at least one depolymerization catalyst (D1) is selected from Brønsted bases.

If the process according to the invention comprises step (ii) it is preferable when the depolymerization catalyst (D1) employed is a Brønsted acid, preferably trifluoromethanesulfonic acid, and the depolymerization catalyst (D2) employed is a Brønsted base, preferably a tetraalkylphosphonium hydroxide and/or alkali metal hydroxide, in particular tetrabutyl hydroxide and/or potassium hydroxide. It is preferable when the deactivation of the depolymerization catalyst (D1) in step (ii) is carried out with a carbonate, in particular anhydrous sodium carbonate.

From a process engineering standpoint it is advantageous if step (ii) of the process may be eschewed. It may thus likewise be preferable when the process according to the invention does not comprise step (ii).

If the process according to the invention does not comprise step (ii) it is preferable when the depolymerization catalyst (D1) employed is a tetraalkylphosphonium hydroxide, in particular tetrabutyl hydroxide.

Step (i) and optional step (ii) of the process effect the depolymerization of the silicone constituent of the silicone waste. Step (iii) of the process then effects distillative removal of one or more cyclosiloxanes from the reaction mixture.

It is preferable when step (iii) is carried out at a temperature of 85° C. to 180° C., preferably of 90° C. to 130° C., in particular of 90° C. to 120° C. It is further preferable when step (iii) is performed at a pressure of at most 70 mbar, preferably of 1 to 40 mbar, in particular of 2 to 30 mbar. It is likewise preferable when step (iii) is performed over a period of at most to 24 h, preferably of 1 h to 22 h, in particular of 2 h to 20 h. It is advisable to perform the distillation under inert gas, preferably with light nitrogen blanketing. The temperature and pressure are adjusted such that constant distillation without excessive foaming is effected. Upon slowing of the distillation the temperature may be increased gradually and/or the vacuum intensified gradually and, optionally with introduction of nitrogen under the liquid level, the yield increased. If required a pre-run of distillate is withdrawn separately before the main fraction is collected.

It is preferable to perform the process according to the invention in a reactor having a volume of preferably at least 1 litre, by preference at least 5 litres, in particular at least 10 litres. It is further preferable when the volume of the reactor is at most 500 000 litres, preferably 30 000 litres, in particular 15 000 litres.

It is further preferable to perform the process according to the invention in a reactor having a water separator and one or more distillation columns. The at least one column may in each case independently be unpacked or packed with any customary packing bodies as desired. The at least one column may be temperature-controllable either over its entirety or zonewise, from heating to cooling. It is likewise preferable to employ, in addition to the column, at least one further cooler with temperature control that is variably controllable via cooling brine. It is likewise preferable to employ a reflux cooler in order thus to effect complete or partial recycling of the distillate.

The term “reactor” is well known to those skilled in the art and therefore needs no separate explanation. A reactor usually, and thus also preferably for the purposes of the present invention, refers to a defined space, for example a stirred container (e.g. a stirred-tank reactor) or a pipe (e.g. flow tube as a flow reactor), in which chemical transformations can be carried out in a selective manner. As is known to those skilled in the art, these may be open or closed containers in which the reactants are converted into the desired products or intermediates. The volume of reactors is stated by the manufacturer or may be determined by volumetric measurement. The reactor material may preferably be selected from materials suitable for this purpose, such as advantageously glass or ceramic, preferably from metal, more preferably highly alloyed stainless steels and particular preferably from Hastelloy. All this is known to those skilled in the art. Suitable reactors are preferably equipped with apparatuses that allow mixing of the reaction mass. Suitable stirring means are known to those skilled in the art and comprise for example dissolvers, propeller stirrers, anchor stirrers, bar stirrers, magnetic stirrers, cup stirrers, jet mixers or inclined blade stirrers. The reactor itself should—if not electrically heated—preferably be equipped with a heating jacket that permits coupling to a suitable heat transfer medium circuit (for example based on heat-transfer oil or superheated steam). Heating or cooling of the reaction mass may be effected using any known means such as for example a double jacket, full pipe coils or half pipe coils and any known coolants. As regards modes of operation, a distinction can essentially be made between a continuous and a discontinuous operating mode. For large product quantities continuous processes may preferably be employed while smaller product quantities are preferably produced in batchwise operation. All this is familiar to those skilled in the art. Reactors, such as especially stirred-tank reactors, are commercially available in very wide variety, for example from Behälter KG Bremen GmbH & Co, Theodor-Barth-Str. 25, 28307 Bremen, Germany, or for example from Buchi AG, Gschwaderstrasse 12, 8610 Uster, Switzerland. Supplementary reference is also made to the book “Chemiereaktoren: Grundlagen, Auslegung und Simulation (Deutsch), 19 Apr. 2017, Jens Hagen” and to the book “Handbuch Chemische Reaktoren, Grundlagen und Anwendungen der Chemischen Reaktionstechnik, edited by Reschetilowski, Wladimir, Springer, Berlin; 1st Edition 2020”; as well as to the book by Klaus Hertwig and Lothar Martens: Chemische Verfahrenstechnik: Berechnung, Auslegung und Betrieb chemischer Reaktoren, Oldenbourg, Munich 2007.

As is more particularly elucidated hereinbelow, the process according to the invention allows the production of cyclosiloxanes having a low carbon footprint. It is preferable when the carbon footprint of the at least one cyclosiloxane produced according to the invention according to DIN EN ISO 14067 (in particular DIN EN ISO 14067:2019-02) is less than 5, preferably less than 4.5, in particular less than 4, kg of CO₂ per kg of cyclosiloxane.

As explained in detail hereinabove the choice of solvent is decisive for the process. The invention thus further provides for the use of the at least one aliphatic hydrocarbon (K) as described hereinabove as a solvent or as a solvent constituent in the production of at least one cyclosiloxane, preferably of cyclosiloxanes, from silicone waste.

As likewise described hereinabove the process according to the invention allows production of single cyclosiloxanes or cyclosiloxane mixtures in high purity.

The invention thus further provides a composition obtained as a distillate of the process according to the invention, wherein the mass fraction of the entirety of all cyclosiloxanes based on the total mass of the composition is at least 90%, preferably at least 92%, in particular at least 94% and the mass fraction of the entirety of all aliphatic hydrocarbons (K) based on the total mass of the composition is at most 10%, preferably at most 8%, in particular at most 6%.

It is further preferable when the mass fraction of water in the composition according to the invention is less than 0.3%, preferably less than 0.2%, in particular less than 0.1%, based on the total mass of the composition. It is very particularly preferable when the composition according to the invention is (substantially) anhydrous. The mass fraction of water in the composition according to the invention is very particularly preferably 0.0% based on the total mass of the composition.

It is preferable when the composition according to the invention comprises or consists of the following cyclosiloxanes:
hexamethylcyclotrisiloxane (D₃) in a mass fraction of 1% to 90%, preferably of 1% to 30%, in particular of 1% to 20%;
octamethylcyclotetrasiloxane (D₄) in a mass fraction of 1% to 90%, preferably of 1% to 85%, in particular of 1% to 80%;
decamethylcyclopentasiloxane (D₅) in a mass fraction of 1% to 90%, preferably of 1% to 85%, in particular of 1% to 70%;
dodecamethylcyclohexasiloxane (D₆) in a mass fraction of 0% to 90%, preferably of 1% to 15%, in particular of 1% to 10%;
tetradecamethylcycloheptasiloxane (D₇) in a mass fraction of 0% to 10%, preferably of 0% to 5%, in particular of 0% to 2%;
hexadecamethylcyclooctasiloxane (D₈) in a mass fraction of 0% to 10%, preferably of 0% to 5%, in particular of 0% to 2%;
   in each case based on the total mass of all cyclosiloxanes.

It is likewise preferable when the composition according to the invention comprises or consists of the following cyclosiloxanes:
hexamethylcyclotrisiloxane (D₃) in a mass fraction of 5% to 90%, preferably of 5% to 30%, in particular of 5% to 20%;
octamethylcyclotetrasiloxane (D₄) in a mass fraction of 1% to 90%, preferably of 1% to 85%, in particular of 1% to 80%;
decamethylcyclopentasiloxane (D₅) in a mass fraction of 1% to 90%, preferably of 1% to 85%, in particular of 1% to 70%;
dodecamethylcyclohexasiloxane (D₆) in a mass fraction of 0% to 90%, preferably of 1% to 15%, in particular of 1% to 10%;
tetradecamethylcycloheptasiloxane (D₇) in a mass fraction of 0% to 10%, preferably of 0% to 5%, in particular of 0% to 2%;
hexadecamethylcyclooctasiloxane (D₈) in a mass fraction of 0% to 10%, preferably of 0% to 5%, in particular of 0% to 2%;
   in each case based on the total mass of all cyclosiloxanes.

The cyclosiloxanes/cyclosiloxane mixtures produced by the process according to the invention are suitable in the context of upcycling for production of silicone articles.

The invention thus further provides for the use of the at least one cyclosiloxane produced by the process according to the invention or of the composition according to the invention for production of silicones, preferably selected from the group consisting of organomodified siloxanes, silicone oils, silicone rubbers and silicone elastomers.

According to the study “Silicon-Chemistry Carbon Balance: An assessment of greenhouse gas and reductions” (https://www.silicones.eu/wp-content/uploads/2019/05/SIL_exec-emissions summary_en.pdf) by the Global Silicones Council the production of silicones from silicon metal by conventional Müller-Rochow synthesis causes greenhouse gas emissions of approximately 6 kg of CO₂ per kg of silicone (polydimethylsiloxane, PDMS). According to the standard DIN EN ISO 14067 for determining the CO₂ footprint of products it is possible to consider the partial lifecycle of a product whose CO₂ emissions relate only to the production of the product and not yet to the use of the product. Compared to the classic Müller-Rochow synthesis the process according to the invention is characterized by substantially lower process temperatures and the absence of chlorine or alkyl chlorides. The use of the at least one cyclosiloxane produced by the process according to the invention or the composition according to the invention makes it possible to achieve more sustainable production of specialty silicones since less energy is required and there is no longer the potential for emissions of HCl or alkyl chlorides. Depending on the silicone wastes employed in each case with different contents of D units the process according to the invention makes it possible to produce special silicones whose greenhouse gas emissions are less than 5, preferably less than 4, kg of CO₂ per kg of D units (where D=[R₂SiO_{2/2}] and R=methyl), wherein the silicones are preferably selected from the group consisting of organomodified siloxanes, silicone oils, silicone rubbers and silicone elastomers.

These silicones thus produced, preferably selected from the group consisting of organomodified siloxanes, silicone oils, silicone rubbers and silicone elastomers, are of high quality and are employable without limitation in the customary fields of application.

The invention thus further provides silicones, preferably selected from the group consisting of organomodified siloxanes, silicone oils, silicone rubbers or silicone elastomers produced using the at least one cyclosiloxane produced by the process according to the invention or using the composition according to the invention.

The invention thus further provides for the use of the correspondingly produced silicones, preferably selected from organomodified siloxanes, as plastics additives, defoamers, foam stabilizers (for example polyurethane foam stabilizers), emulsifiers, demulsifiers, rheology additives, hydrophobizing agents, wetting agents, textile additives, paint additives, levelling additives, dispersing additives or as additions in polishes, cleaning compositions and cosmetic preparations or for producing silicone release coatings.

### EXAMPLES

The following examples serve only to explain the present invention for those skilled in the art and do not constitute any restriction whatsoever of the claimed subject matter.

### General Methods

### Nuclear Magnetic Resonance Spectroscopy (NMR Spectroscopy):

Characterization of the organosiloxanes may be effected using ¹H- and ²⁹Si-NMR spectroscopy. These methods, especially taking account of the multiplicity of the couplings, are familiar to the person skilled in the art.

### Gas Chromatography:

Gas chromatographic measurements (GC measurements) were carried out according to DIN 51405 (January 2004 edition). A gas chromatograph fitted with a FID detector and capillary column (Agilent HP1) is used. 200 mg of sample substance are dissolved in 10 ml of acetone p.a. and dodecane (>99.8%) is used as the internal standard.

Unless otherwise stated all percentages are to be understood as meaning percentages by weight (mass fractions).

### Raw Materials

Tetrabutane: Mixture of branched paraffins with C₁₆-hydrocarbons as main constituent (Evonik)
Shell Risella X 430: Paraffin oil having a kinematic viscosity of 44 mm²/s at 40° C. and a Noack evaporation loss of 1.8% at 250° C. within 1 h
TEGOSOFT® IHD BASIC: Mixture of branched C₁₆-, C₂₀- and C₂₄-alkanes (Evonik)
TEGO® Antifoam MR 1015: defoamer (Evonik)
Silicone oil 5: Xiameter PMX-200 Silicone Fluid 5 cSt (Dow)
Silicone oil 10: Xiameter PMX-200 Silicone Fluid 10 cSt (Dow)
Photoinitiator TEGO® A18: Photoinitiator (Evonik)

### Synthesis Examples

### Example 1 (Inventive)

In a 1000 ml four-necked glass flask fitted with a stirrer, a reflux cooler, a manometer and a heating mantle with integrated thermocouple, 309.7 g of a pasty, addition-crosslinkable LSR compound having an SiO₂ filler content of about 50% are weighed in using a cartridge. After addition of 309.7 g of tetrabutane as solvent, 14.1 g of hexamethyldisiloxane and 0.65 g of trifluoromethanesulfonic acid, the mixture is slowly heated to 90° C. with stirring. After adding another 50 g of tetrabutane the mixture is stirred at 90° C. for 6 h. After cooling to 60° C., 3.3 g of sodium carbonate are added and the mixture is stirred at 60° C. for 3 h. The filler is filtered off via a pressure filter press. In a distillation apparatus 250 g of the filtrate are admixed with 5 g of finely mortared potassium hydroxide and heated to 120° C. with stirring. 50 mg of TEGOR Antifoam MR 1015 are added, the pressure is gradually reduced to 25 mbar and the mixture is distilled for 2.5 h. The total yield of distillate is 83.2 g. This is followed by distillation at 15 mbar for one hour and at 10 mbar for a further 2.5 h. 83.2 g of distillate are obtained. According to ¹H and ²⁹Si NMR analysis the distillate contains 5.4% of the the employed solvent; 17.3% of hexamethylcyclotrisiloxane (D₃), 66.5% of octamethylcyclotetrasiloxane (D₄) and 10.8% of decamethylcyclopentasiloxane (D₅).

### Example 2 (Inventive)

In a 2000 ml four-necked glass flask fitted with a stirrer, a reflux cooler, a manometer and a heating mantle with integrated thermocouple, 500 g of shredded silicone rubber wastes (variously coloured) are initially charged and after addition of 400 g of tetrabutane as solvent, 11.4 g of hexamethyldisiloxane and 1.0 g of trifluoromethanesulfonic acid the mixture is initially heated to 80° C. with stirring and after 1 h of stirring time further heated to 100° C. After stirring for 5.5 h at 100° C. there are no longer any solid silicone rubber particles detectable. After addition of 2.6 g of anhydrous sodium carbonate the mixture is stirred at 100° C. for a further hour. The reflux cooler is then replaced by a Vigreux column and distillation bridge, 5.11 g of tetramethylammonium hydroxide monohydrate is added, the mixture is stirred at 100° C. for 30 min and then the pressure is reduced to 30 mbar to 20 mbar. The distillate pre-run is disposed of and the mixture is then distilled for a total of 11 h at 100° C. to 111° C. and 9 mbar to 7 mbar. 128 g of distillate are obtained. According to ¹H and ²⁹Si NMR analysis the distillate contains 1.1% of the employed solvent; 17.3% of hexamethylcyclotrisiloxane (D₃), 74.2% of octamethylcyclotetrasiloxane (D₄) and 7.0% of decamethylcyclopentasiloxane (D₅).

### Example 3a (Inventive)

1376 g of variously coloured comminuted silicone rubber pieces (0.5-1 cm diameter) are initially charged in a 4000 ml four-necked glass flask fitted with a stirrer, a reflux cooler, a manometer and a heating mantle with integrated thermocouple and heated to 40° C. with 1376 g of TEGOSOFT® IHD BASIC as solvent and 89.3 g of a dioctylpolydimethylsiloxane having a molar weight of 1100 g/mol with stirring. 2.9 g of trifluoromethanesulfonic acid are added and the mixture is stirred at 100° C. to 120° C. for 4 h until all rubber particles have dissolved. 7.3 g of anhydrous sodium carbonate are added at 100° C. and the mixture is stirred for 2 h.

### Example 3b (Inventive)

In a 2000 ml four-necked flask fitted with a stirrer, a Vigreux column and distillation bridge, a manometer and a heating mantle with integrated thermocouple, 914 g of the reaction mixture from example 5a are admixed with 4.7 g of tert-butylimino-tri(pyrrolidino)phosphorane (>97%, Sigma Aldrich) at 80° C. with stirring and the resulting mixture is heated to 122° C. 248 g of distillate are obtained at 122° C. and 8 mbar to 4 mbar.

### Example 3c (Inventive)

In a 2000 ml four-necked flask fitted with a stirrer, a Vigreux column and distillation bridge, a manometer and a heating mantle with integrated thermocouple, 914 g of the reaction mixture from example 5a are admixed with 4.7 g of tetramethylguanidine at 94° C. with stirring and the resulting mixture is heated to 122° C. 96 g of distillate are obtained at 122° C. and 4 mbar to 2 mbar.

### Example 4 (Inventive)

In a 1000 ml four-necked glass flask fitted with a stirrer, a reflux cooler, a manometer and a heating mantle with integrated thermocouple, 300 g of shredded, colourless silicone hoses are initially charged. After addition of 50 g of a trimethylsiloxy-terminated silicone oil having a viscosity of 10 mm²/s, 300 g of TEGOSOFT® IHD BASIC as solvent and 8.8 g of 40% aqueous tetrabutyl phosphonium hydroxide solution, the mixture is stirred at 110° C. for 4 h with initial foaming, a further 75 g of TEGOSOFT® IHD BASIC being added after 1 h. The reflux cooler is then replaced by a Vigreux column and distillation bridge and water is removed at 110° C. 184 g of distillate are then obtained at 106° C. to 108° C. and 7 mbar to 6 mbar over 11 h. According to ¹H and ²⁹Si NMR analysis the distillate contains 2.5% of the employed solvent; 10.6% of hexamethylcyclotrisiloxane (D₃), 79% of octamethylcyclotetrasiloxane (D₄) and 5.9% of decamethylcyclopentasiloxane (D₅).

### Example 5 (Inventive)

In a 500 ml four-necked glass flask fitted with a stirrer, a reflux cooler, a manometer and a heating mantle with integrated thermocouple, 318 g of a cyclosiloxane mixture produced according to example 4 having a purity of 97.7%, 0.37 g of trifluoromethanesulfonic acid and 60.24 g of a silicone acrylate produced according to EP 0940422 B1 example 1 were successively initially charged with stirring and stirred at 100° C. for 10 h. After cooling to 70° C., 2.65 g of anhydrous sodium carbonate are added and the mixture is stirred at 70° C. for 3 h. After addition of 1.5 g of filtration aid the mixture is filtered via a filter press with an HS 2000 sheet filter and the yellowish-brown product is freed of volatile constituents using a thin-film evaporator at 130° C. and <1 mbar. This affords a yellowish-brown silicone acrylate having a viscosity of 446 mPa·s at 25° C.

### Example 6a (Inventive)

In a 1000 ml four-necked glass flask fitted with a stirrer, a reflux cooler, a manometer and a heating mantle with integrated thermocouple, 380.3 g of a cyclosiloxane mixture produced according to example 4 having a purity of 97.7%, 54.9 g of hexamethyldisiloxane and 123.5 g of poly(methylhydro)siloxane are initially charged with stirring, 0.56 g of trifluoromethanesulfonic acid are added and the mixture is stirred at 40° C. for 2 h and stirred at room temperature for a further 14 h. 8.4 g of sodium hydrogencarbonate are then added and the mixture is stirred at room temperature for 2 h. Filtration afforded a colourless, clear hydrosiloxane having an SiH content of 3.4 mmol/g and a viscosity of 10.1 mPa·s at room temperature.

### Example 6b (Inventive)

In a 1000 ml four-necked glass flask fitted with a stirrer, a reflux cooler, a manometer and a heating mantle with integrated thermocouple, 192.9 g of allyl glycidyl ether are now initially charged and admixed with 3 ppm of platinum in the form of Karstedt catalyst. After inertization and heating to 95° C., 379.8 g of the hydrosiloxane from example 6a are metered in within half an hour and the temperature is maintained at about 100° C. by countercooling. After 7 h of stirring at 100° C., the SiH content of the mixture determined by gas volumetric means is no longer measurable and corresponds to 100% reaction conversion. Distillation using a rotary evaporator at 135° C. and <0.1 mbar for 1 h affords a clear, slightly brownish epoxysiloxane having an epoxy content of 4.05% epoxy oxygen.

### Example 6c (Inventive)

In a 500 ml four-necked glass flask fitted with a stirrer, a reflux cooler, a manometer and a heating mantle with integrated thermocouple, 44.39 g of acrylic acid, 5.04 g of concentrated acetic acid and 68 mg of methylhydroquinone are now initially charged and admixed with 0.45 g of 50% aqueous chromium (III) acetate solution. The mixture is heated to 65° C. with stirring and the epoxysiloxane from example 6b is metered in over 1 h. The temperature was continuously increased to 90° C. during metered addition and the mixture was then stirred for 5 h at 95° C. During cooling 1 g of filtration aid is stirred in and the product filtered via a filter press with a KD 5 sheet filter. A greenish clear silicone acrylate having a viscosity of 469 mPa·s is obtained at room temperature.

### Example 7 (Non-Inventive)

In a 1000 ml four-necked glass flask fitted with a stirrer, a reflux cooler, a manometer and a heating mantle with integrated thermocouple, 286 g of decamethylcyclopentasiloxane (D₅), 13.9 g of hexamethyldisiloxane and 30 g of silicone oil 10 are initially charged and 203 g of a pasty, addition-crosslinkable LSR compound having an SiO₂ filler content of about 50% are added in four portions using a cartridge and the mixture is heated to 90° C. with stirring. After addition of 15 g of potassium methoxide, the reaction mixture was gradually heated to 140° C. and distillation was commenced at 890 mbar. Gelation of the column bottoms occurred after 1 h of distillation time. 153 g of distillate, which comprises 95.3% of decamethylcyclopentasiloxane (D₅) according to ²⁹Si-NMR, were obtained.

### Example 8 (Non-Inventive)

In a 500 ml four-necked glass flask fitted with a stirrer, a reflux cooler, a manometer and a heating mantle with integrated thermocouple, 200 g of isononanol as solvent, 6.8 g of hexamethyldisiloxane, 0.63 g of trifluoromethanesulfonic acid and 108 g of a pasty, addition-crosslinkable LSR compound having an SiO₂ filler content of about 50% are heated to 90° C. with stirring and stirred for 2 h. After addition of 1.6 g of anhydrous sodium carbonate the mixture is stirred at 60° C. for 2 h and filtered through a coarse pleated filter. 250 g of the filtrate are heated to 100° C. with stirring and 7.5 g of finely mortared potassium hydroxide are added. After 30 min of stirring at 100° C. a vacuum is applied and the temperature is increased. The mixture is distilled at 115° C. to 150° C. and 715 mbar to 600 mbar for 1.5 h. Gelation of the column bottoms occurred after 1.5 h of distillation time. 152 g of distillate, which consists predominantly of isononanol according to ¹H-NMR, were obtained.

### Example 9 (Non-Inventive)

In a 500 ml four-necked glass flask fitted with a stirrer, a reflux cooler, a manometer and a heating mantle with integrated thermocouple, 22.6 g of silicone oil 5, 0.25 g of trifluoromethanesulfonic acid and 105 g of a pasty, addition-crosslinkable LSR compound having an SiO₂ filler content of about 50% are heated to 100° C. with stirring. After addition of another 22.6 g of silicone oil 5 and 105 g of pasty, addition-crosslinkable LSR compound the mixture is subjected to further stirring. After addition of 11.3 g of silicone oil 5 the mixture is stirred at 150° C. for 4 h and again at 130° C. for 2 h. After cooling to 60° C., 0.9 g of anhydrous sodium carbonate were added and the mixture was stirred for 2 h. It is filtered through a paint filter having a pore size of 125 μm. 127 g of the filtrate are heated to 190° C. with 2.5 g of concentrated sulfuric acid with stirring and 2 ml to 3 ml of distillate are removed at atmospheric pressure. After cooling to 150° C., a further 2.5 g of concentrated sulfuric acid are added and heated to 190° C. No more distillate was obtained and the column bottoms became highly viscous.

### Example 10 (Non-Inventive)

In a 1000 ml four-necked glass flask fitted with a stirrer, a reflux cooler, a manometer and a heating mantle with integrated thermocouple, 300 g of shredded, colourless silicone hoses are initially charged and after addition of 300 g of butyl diglycol (2-(2-butoxyethoxy) ethanol), 31.4 g of a dioctyl polydimethylsiloxane having a molar weight of 1100 g/mol and 8.3 g of a 40% aqueous tetrabutyl phosphonium hydroxide solution with stirring the mixture was heated to 125° C. with stirring and stirred for 3 h. The silicone pieces have not dissolved.

### Example 11 (Non-Inventive)

In a 2000 ml four-necked glass flask fitted with a stirrer, a reflux cooler, a manometer and a heating mantle with integrated thermocouple, 650.2 g of shredded, coloured silicone rubber wastes are initially charged and after addition of 57.6 g of a dioctylpolydimethylsiloxane having a molar weight of 1100 g/mol, 650.2 g of dodecane as solvent and 1.4 g of trifluoromethanesulfonic acid, the mixture is stirred at 100° C. for 6 h. After addition of 3.5 g of anhydrous sodium carbonate the mixture is stirred at 100° C. for 1 h. The reflux cooler is then replaced by a Vigreux column and distillation bridge, 17.7 g of 40% aqueous tetrabutylphosphonium hydroxide solution are added and the mixture is distilled at 85° C. to 100° C. and pressure gradually reduced to 10 mbar. After 2.5 h of distillation time the column bottoms have dried up, are detachable from the periphery of the flask as dark lumps and weigh 432 g. 823 g of distillate are obtained. According to ¹H and ²⁹Si NMR analysis the distillate contains 67% of the employed solvent, 2.6% of hexamethylcyclotrisiloxane (D₃), 21.5% of octamethylcyclotetrasiloxane (D₄) and 8% of decamethylcyclopentasiloxane (D₅).

### Example 12 (Inventive)

In a 1000 ml four-necked glass flask fitted with a stirrer, a reflux cooler, a manometer and a heating mantle with integrated thermocouple, 300 g of shredded, coloured silicone rubber wastes, 300 g of Shell Risella X 430 and 6 g of concentrated sulfuric acid (98%) are initially charged and stirred at 100° C. for 6 h. After addition of 6.6 g of anhydrous sodium carbonate the mixture is stirred at 70° C. for 2 h. The reflux cooler is then replaced by a Vigreux column and distillation bridge and 7.5 g of 40% aqueous tetrabutylphosphonium hydroxide solution are added. The mixture is distilled at 105° C. to 130° C. and the pressure gradually reduced to 9 mbar. 36 g of distillate are obtained in the first 30 min, then the distillation comes to a standstill and the viscosity of the bottoms increases. A further 7.5 g of 40% aqueous tetrabutylphosphonium hydroxide solution are added and it is possible to obtain another 14.7 g of distillate before the distillation comes to a standstill again and the experiment is terminated. The amount of distillate is only 30% of theory and additionally consists of a water phase and a silicone phase. According to ¹H and ²⁹Si NMR analysis the distillate contains 7.7% of hexamethylcyclotrisiloxane (D₃), 78.3% of octamethylcyclotetrasiloxane (D₄) and 12.2% of decamethylcyclopentasiloxane (D₅).

### Performance Testing

### Production of Release Coatings:

The performance testing of the silicone acrylates from inventive examples 5 and 6c is carried out in formulations for release coatings. Release coatings are known from the prior art, particularly as adhesive coatings on sheetlike carriers and especially for their use in adhesive tapes or label laminates.

To produce the formulations for release coatings in each case 98 g of the silicone acrylates from examples 5 and 6c and in each case 2 g of photoinitiator TEGO® A18 were intensively mixed (examples A and B).

Also produced is a release coating formulation where 30 g of the component from example 6c is mixed with 68 g of the component from example 5 and 2 g of the photoinitiator TEGO® A18 (example C).

The coating compositions thus produced are applied to a sheetlike carrier. In all performance examples, this consists of a 50 cm wide, biaxially oriented polypropylene film (BOPP) which, in each case before application of the coating composition, was subjected to a corona pre-treatment with a generator output of 1 KW. The coating materials are applied using a 5-roll coating unit from COATEMA® (Coating Machinery GmbH, Dormagen, Germany) with a weight per unit area of about 1 g/m² and were cured by the action of UV light from a medium-pressure mercury vapour lamp from IST® Metz GmbH (Nürtingen, Germany) at 60 W/cm and at a belt speed of 100 m/min under a nitrogen atmosphere with a residual oxygen content of less than 50 ppm.

The samples thus coated are subjected to a test with respect to rub-off, release force and residual adhesive force.

### Rub-Off:

The adhesion of the cured coating to the carrier material is verified by vigorous rubbing with the thumb on the coating. In case of insufficient adhesion, abraded material in the form of rubbery-looking crumbs is formed. Such crumbs ought not to be produced even on intense rubbing. The test is carried out by a trained panel. The assessment is categorized in ranges from 1 to 5, where 1 is very good and 5 is rather poor adhesion to the carrier material.

### Release Force:

The release effect with respect to adhesive materials, in industrial application usually in the form of adhesive tapes or labels, is expressed by the release force (RF), with a low release force describing a good release effect. The release force is dependent on the quality of the release coating, on the adhesive itself and on the test conditions. For evaluation of release coatings identical adhesives and test conditions therefore ought to be present. For the determination of the release forces, adhesive tapes or label laminates are cut to a width of 2.5 cm and then the adhesive side thereof is applied in each case to the silicone coating under test. This test is carried out in accordance with FINAT Handbook, 8th Edition, The Hague/NL, 2009 under designation FTM 10, with the modification that storage is carried out under pressure at 40° C. The adhesive tape employed is Tesa® 7475 (trade mark of Tesa SE, Hamburg, Germany). The values reported are in each case average values from a five-fold determination and are stated in units [cN/2.5 cm]. Systems with a release force below 10 cN/2.5 cm are classified as easy release and are typically suitable for many applications such as label laminates for example.

### Residual Adhesive Force:

The residual adhesive force (short-term residual adhesive force: RAF) is determined according to the test protocol FTM 11 in FINAT Handbook 8th Edition, The Hague/NL, 2009 with the exception that storage of the test adhesive strip in silicone contact is carried out for one minute and the standard surface is an untreated BOPP surface. The adhesive tape employed is Tesa® 7475 (trade mark of Tesa SE, Hamburg, Germany). The residual adhesive force is a measure of the crosslinking of the silicones. If non-polymerized and thus migratable silicone constituents are present, residual adhesive force values decrease with increasing proportion of such components. Values above 80% are regarded as acceptable. The results of the rub-off test, the release forces and the short-term residual adhesive forces (RAF) are shown in Table 1.

TABLE 1
Results of performance testing (rub-off in grades of 1
to 5; release forces (RF) in cN/2.5 cm after 24 hours
storage at 40° C.; residual adhesive force (RAF) in %).

| | | RF (tesa ® 7475) | RAF |
|---|---|---|---|
| Example | Rub-off | [cN/2.5 cm] | [%] |
| A | 5 | 7 | 91 |
| B | 1 | 410 | 96 |
| C | 2 | 8 | 92 |

The examples exhibit good curing which is evident from the short-term residual adhesive forces (RAF). The separation values too show an expected picture of low and high release forces depending on the acrylate density and functionalization. Good rub-off requires a silicone component having a high acrylate density and so example A shows only inadequate rub-off while examples B and C show the opposite behaviour.

1. A process for producing at least one cyclosiloxane by catalyzed depolymerization of silicone waste, the process comprising:
(i) dissolving at least a portion of the silicone waste in at least one solvent containing or consisting of at least one aliphatic hydrocarbon (K) using at least one depolymerization catalyst (D1),
(ii) optionally deactivating the at least one depolymerization catalyst (D1) and adding at least one further depolymerization catalyst (D2),
(iii) distillative removal of the at least one cyclosiloxane from the mixture,
wherein the at least one aliphatic hydrocarbon (K) comprises at least 16 carbon atoms.

2. The process according to claim 1, wherein the silicone waste contains or consists of silicone elastomers and/or silicone rubbers.

3. The process according to claim 1, wherein the at least one depolymerization catalyst (D1) and optionally the at least one depolymerization catalyst (D2) is selected from the group consisting of Brønsted acids, and Brønsted bases.

4. The process according to claim 1, wherein (i) employs 0.05 to 10 parts by weight of the at least one depolymerization catalyst (D1) and optionally of the at least one depolymerization catalyst (D2) based on 100 parts by weight of a silicone constituent of the silicone waste.

5. The process according to claim 1, wherein a mass fraction of an entirety of the at least one aliphatic hydrocarbon (K) in the at least one solvent, based on a total mass of the at least one solvent, is at least 99.0%.

6. The process according to claim 1, wherein
an evaporation loss of the at least one solvent and/or of the at least one aliphatic hydrocarbon (K) determined according to ASTM D972 after 22 h at 107° C. is at most 0.8%, reported as the mass loss based on initial mass; and/or
the Noack volatility of the at least one solvent and/or of the at least one aliphatic hydrocarbon (K) determined according to ASTM D5800 after 1 h at 250° C. is at most 40%, reported as the mass loss based on initial mass; and/or
the Noack evaporation loss of the at least one solvent and/or of the at least one aliphatic hydrocarbon (K) determined according to DIN 51581 after 1 h at 250° C. is at most 40%, reported as the mass loss based on initial mass.

7. The process according to claim 1, wherein
the at least one aliphatic hydrocarbon (K) is a branched alkane; and/or
the at least one solvent is selected from the group consisting of fuel oil, diesel, paraffin oil, white oil and tetrabutane.

8. The process according to claim 1, wherein at least one silicone additive selected from the group consisting of hexamethyldisiloxane, polydimethylsiloxane, α,ω-dialkoxypolydimethylsiloxane, divinyltetramethyldisiloxane or α,ω-divinylpolydimethylsiloxane, α,ω-dialkylpolydimethylsiloxane, and siloxanes functionalized with polyethers or glycols is additionally employed in (i) and/or (ii).

9. The process according to claim 1, wherein (i)
is performed at a temperature of 30° C. to 180° C.; and/or
is performed at standard pressure (1013.25 hPa)+500 hPa.

10. The process according to claim 1, wherein the process comprises (ii) and the at least one depolymerization catalyst (D1)
a) is deactivated with at least one Brønsted base when the at least one depolymerization catalyst (D1) is selected from Brønsted acids; or
b) is deactivated with at least one Brønsted acid when the at least one depolymerization catalyst (D1) is selected from Brønsted bases.

11. The process according to claim 1, wherein (iii)
is performed at a temperature of 85° C. to 180° C.; and/or
at a pressure of at most 70 mbar.

12. The process according to claim 1, wherein the carbon footprint of the at least one produced cyclosiloxane according to DIN EN ISO 14067 is less than 5 kg of CO₂ per kg of cyclosiloxane.

13. A method, comprising:
producing of at least one cyclosiloxane from silicone waste,
wherein at least one aliphatic hydrocarbon (K) as specified according to claim 1 is used in the method as a solvent or as a solvent constituent.

14. A composition obtained as a distillate of the process according to claim 1, wherein a mass fraction of the entirety of all cyclosiloxanes based on a total mass of the composition is at least 90% and the mass fraction of the entirety of the at least one aliphatic hydrocarbon (K) based on the total mass of the composition is at most 10%.

15. A method, comprising:
producing silicones,
wherein the at least one cyclosiloxane produced by the process according to claim 1 is used in the method.

16. Silicones produced using the at least one cyclosiloxane produced by the process according to claim 1.

17. The silicones produced according to claim 16, wherein the silicones are configured to be used as plastics additives, defoamers, foam stabilizers, emulsifiers, demulsifiers, rheology additives, hydrophobizing agents, wetting agents, textile additives, paint additives, levelling additives, dispersing additives or as additions in polishes, cleaning compositions and cosmetic preparations or for producing silicone release coatings.
